(19) United States
(12) Patent Application Publication
(10) Pub. No.: US 2017/0009609 A1
(43) Pub. Date: Jan. 12, 2017

(54) TRANSMISSION ASSEMBLY FOR A MECHANICALLY CONTROLLABLE VALVE TRAIN, AND MECHANICALLY CONTROLLABLE VALVE TRAIN

(71) Applicant: PIERBURG GMBH, Neuss (DE)

(72) Inventors: STEPHAN SCHMITT, WILLICH (DE); PETER HAUSHAELTER, MOENCHENGLADBACH (DE); MARKUS ILBERTZ, VIERSEN (DE); MANUEL SEIBEL, DORMAGEN (DE)

(73) Assignee: PIERBURG GMBH, NEUSS (DE)

(21) Appl. No.: 15/113,051

(22) PCT Filed: Oct. 28, 2014
(86) PCT No.: PCT/EP2014/073044

§ 371 Date: Jul. 21, 2016

(30) Foreign Application Priority Data
Jan. 23, 2014 (DE) 10 2014 100 748.4

(51) Int. Cl. F01L 1/22; F01L 1/14; F01L 1/18; F16H 25/10; F01L 1/047

(52) U.S. Cl. CPC F01L 1/22; F16H 25/10; F01L 1/047; F01L 1/18; F01L 1/14

(57) ABSTRACT

A transmission assembly for a mechanically controllable valve train. The transmission assembly includes a gas exchange valve, a coupling element, a slotted guide module comprising slotted guide tracks, mounting members, a camshaft, cam following roller elements, at least two transmission elements, and a valve stroke adjustment device. Each transmission element is directly or indirectly in an operative connection with one gas exchange valve via the coupling element. The transmission elements are mounted via the mounting members in the slotted guide tracks. Each transmission element is in an operative connection with the camshaft via the cam following roller elements. The valve stroke adjustment device sets different maximum strokes of a gas exchange valve. The mounting members and the cam following roller elements are mounted on a rotary axis. Each of the cam following roller elements has two mounting members assigned thereto to increase a rigidity of the rotary axis.

### CROSS REFERENCE TO PRIOR APPLICATIONS

This application is a U.S. National Phase application under 35 U.S.C. §371 of International Application No. PCT/EP2014/073044, filed on Oct. 28, 2014 and which claims benefit to German Patent Application No. 10 2014 100 748.4, filed on Jan. 23, 2014. The International Application was published in German on Jul. 30, 2015 as WO 2015/110189 A1 under PCT Article 21(2).

### FIELD

The present invention relates to a transmission assembly for a mechanically controllable valve train, the transmission assembly having at least two transmission elements, wherein, the transmission elements are designed so that they are each directly or indirectly in an operative connection with a respective gas exchange valve via a coupling, the transmission elements are mounted for movement in a slotted guide module by mounting members in a slotted guide system, the transmission elements are also in operative connection with a camshaft via cam following roller elements, a valve stroke adjustment device for setting different maximum strokes of the respective gas exchange valve is provided, and wherein at least one mounting member and cam following roller elements are mounted on a rotary axis. The present invention further relates to a mechanically controllable valve train comprising the above transmission assembly.

### BACKGROUND

An exemplary transmission assembly for the “UniValve” system is described in DE 10 2007 022 266 A1. The transmission assembly there comprises two transmission elements, each of which act on a gas exchange valve in a known manner. For this purpose, an upper cam following roller element can be driven by a respective camshaft so that the gas exchange valve will respectively be opened and closed between a preset maximum stroke and a minimum stroke or also zero stroke. The respective maximum stroke herein can be set by a valve stroke adjustment device which in turn will act on the respective transmission element. The valve stroke adjustment device is designed in DE 10 2007 022 266 A1 as an eccentric shaft. The transmission assembly herein is movably supported in the cylinder head via a mounting member designed to roll in a slotted guide track. The mounting member is arranged on an axis on which the cam following roller elements are also provided. It has now become evident that this axis may become deflected due to valve spring forces acting on the respective transmission elements, resulting in a possible higher wear of the transmission assembly. Such a situation at the same time has the effect that, in certain load situations, the mounting member will act as a counter bearing and the efficiency of the internal combustion engine will be correspondingly reduced, which will lead to increased fuel consumption.

### SUMMARY

An aspect of the present invention is to avoid the above disadvantages in a simple and inexpensive manner and to thereby enhance the realization of maximum potentials.

In an embodiment, the present invention provides a transmission assembly for a mechanically controllable valve train. The transmission assembly includes at least one gas exchange valve, at least one coupling element, a slotted guide module comprising slotted guide tracks, mounting members, a camshaft, cam following roller elements, at least two transmission elements, and a valve stroke adjustment device. Each of the at least two transmission elements are configured so that a respective transmission element is directly or indirectly in an operative connection with one of the at least one gas exchange valve via one of the at least one coupling element. The at least two transmission elements are mounted via the mounting members in a respective one of the slotted guide tracks of the at least one slotted guide module. Each of the at least two transmission elements are in an operative connection with the camshaft via the cam following roller elements. The valve stroke adjustment device is configured to set different maximum strokes of a respective one of the at least one gas exchange valve. The mounting members and the cam following roller elements are mounted on a rotary axis. Each of the cam following roller elements has two mounting members assigned thereto so as to increase a rigidity of the rotary axis.

### BRIEF DESCRIPTION OF THE DRAWINGS

The present invention is described in greater detail below on the basis of embodiments and of the drawings in which:

FIG. 1 is a perspective view of a mechanically controllable valve train according to the present invention;

FIG. 2 is a sectional view of an embodiment of a transmission assembly according to the present invention;

FIG. 3 is a perspective view of slotted guide tracks from FIG. 2; and

FIG. 4 is a sectional view of an embodiment of a transmission assembly according to the present invention.

### DETAILED DESCRIPTION

In an embodiment, the present invention provides a cam following roller element which has two respective mounting members assigned thereto so that a rigidity of the rotary axis is increased. Deflection of the rotary axis is effectively prevented by such an assignment. This provides an improved rigidity of the overall system of the valve train which is a basic precondition for the dynamics of the valve train, the rotary speed endurance, and the maximum attainable valve acceleration, and thus the potential for optimizing the internal combustion engine with respect to performance and consumption behavior. An optimizing of fuel consumption by higher opening and closing acceleration can also be achieved. This will lead to an optimization of CO₂ emissions and to an increase of the power and the rotary moment of the internal combustion engine. The outer slotted guide tracks can advantageously comprise guide edges arranged at the respective outer side, thus rendering it possible to take up axial forces acting on the rotary axis.

In an embodiment of the present invention, all of the mounting members are arranged serially in a row. The outer mounting members can alternatively extend above the cam following roller elements, with the transmission element modified.

In an embodiment, the present invention provides a mechanically controllable valve train comprising a transmission assembly as described above, wherein at least two serially arranged gas exchange valves have a transmission assembly assigned thereto.

The present invention will be explained in greater detail below with reference to the drawings.

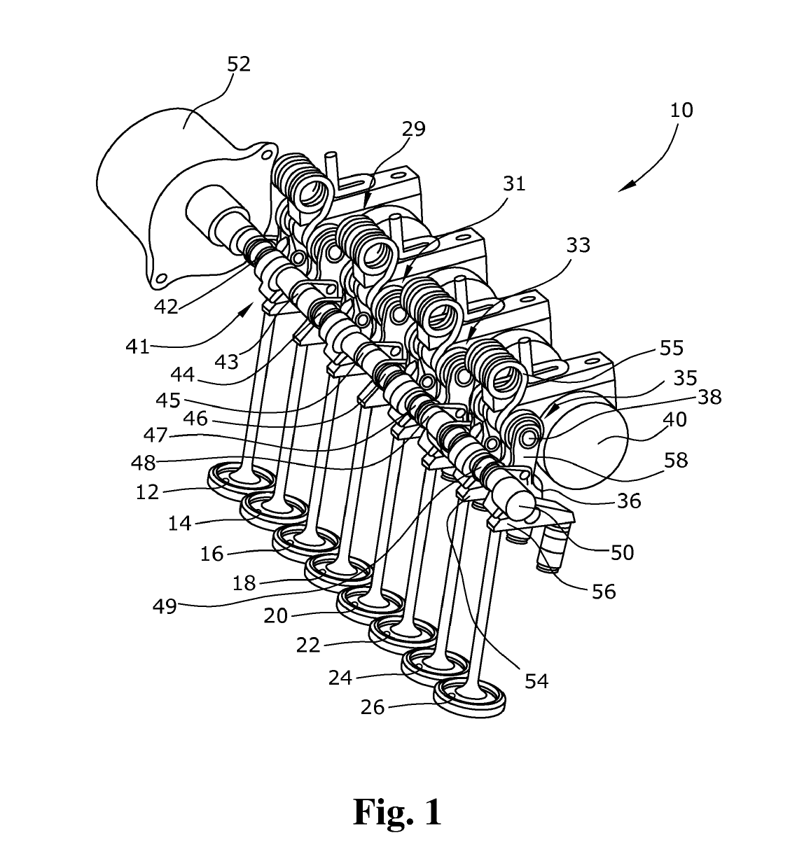

FIG. 1 shows a perspective view of a mechanically controllable valve train 10 comprising a plurality of serially arranged gas exchange valves 12, 14, 16, 18, 20, 22, 24 and 26. In the shown exemplary embodiment, two respective inlet gas exchange valves are assigned to a cylinder of the internal combustion engine. The mechanically controllable valve train 10 comprises, in the present case, four transmission assemblies 29, 31, 33 and 35, each of which have two gas exchange valves 12, 14; 16, 18; 20, 22 and 24, 26 assigned thereto. For the transmission assembly 35, there is depicted in the present view, by way of example, a mounting member 36 by which a rotary axis 38 of transmission assembly 35 is allowed to roll in a known manner on a slotted guide track, which is not shown in greater detail. The transmission assemblies 29, 31, 33 and 35 are also arranged to be in an operative connection with camshaft 40 in a known manner. Each transmission assembly 29, 31, 33 and 35 can also be driven via adjustment members 42, 43; 44, 45; 46, 47 and 48, 49 of a valve stroke adjustment device 41 to allow for a lower or higher maximum stroke of the gas exchange valves 12, 14; 16, 18; 20, 22; 24 and 26. In the shown embodiment, the adjustment members 42, 43; 44, 45; 46, 47 and 48, 49 are respectively assigned the inlet valves 12, 14; 16, 18; 20, 22 and 24, 26 and are designed as eccentric members provided on an eccentric shaft 50 and acting in a known manner on engagement members, which are not shown in greater detail. In the shown embodiment, the eccentric shaft 50 can be driven by a drive member 52 in a known manner. The transmission assembly 35 in the present case acts on pivot lever assemblies 54 and 56, wherein an illustrated transmission element 58 is operatively connected to pivot lever assembly 56 by a working cam, and wherein pivot lever assembly 56, via an end face thereof, is in engagement with gas exchange valve 26. The adjustment members 42, 43; 44, 45; 46, 47 and 48, 49 engage an engagement element (not shown in the drawings) of the intermediate lever arrangement 58 against a biasing force of a spring 55. In certain load situations, a consequence of valve spring forces may be that the rotary axis 38 undergoes a bending deflection with resultant disadvantages.

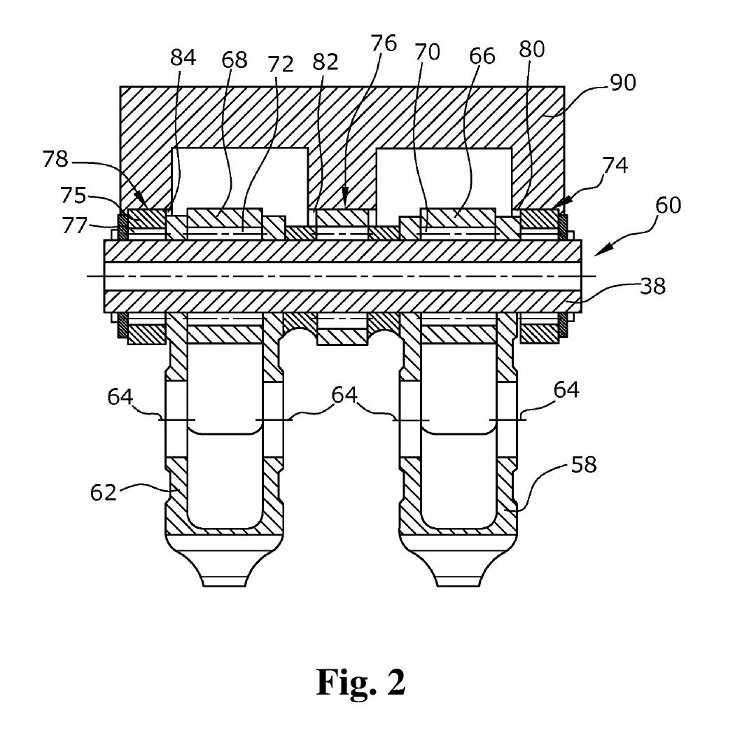

FIG. 2 shows a transmission assembly 60 according to the present invention which can replace the transmission assemblies 29, 31, 33 and 35 of FIG. 1. In the present case, transmission assembly 60 comprises the transmission element 58 already shown FIG. 1 and a second transmission element 62 which is in operative connection with the gas exchange valve 24 of FIG. 1 via a pivot lever assembly 56. Adjustment members, not shown in greater detail, which cooperate with the eccentric shaft 50 of FIG. 1, are supported in a known manner on rotary axes 64. Both transmission elements 58, 62 are arranged on rotary axis 38, wherein each transmission element 58, 62 comprises a cam following roller element 66, 68, each transmission element 58, 62 being supported on rotary axis 38 by needle bearings 70, 72 and being driven by camshaft 40. Transmission assembly 60 also comprises three mounting members 74, 76 and 78 which again consist of a roll 75 and a needle bearing 77 and via which the transmission assembly 60 will roll in corresponding slotted guide tracks 80, 82 and 84. Slotted guide tracks 80, 82 and 84 are provided combined in a slotted guide module 90. The effective rigidity of the rotary axis 38 is thereby considerably enhanced. The slotted guide module 90 herein is provided in a known manner in a cylinder head, which is not shown in greater detail.

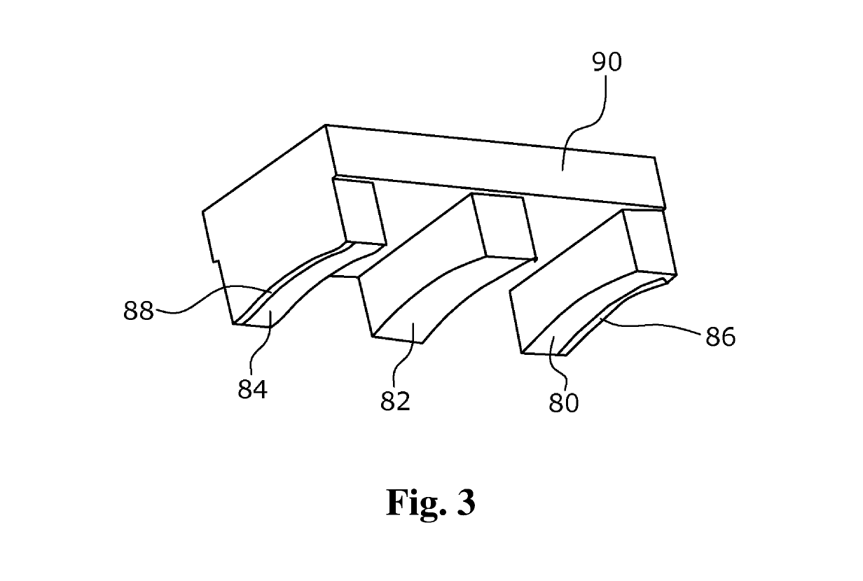

The two outer slotted guides 80, 84 can be designed to have a suitable width in accordance with the force distribution and the available constructional space. The outer slotted guides tracks 80, 84 can also comprise guide edges 86, 88 arranged at the respective outer side that will provide an axial guidance of transmission assembly 60 (see in particular FIG. 3 with regard thereto).

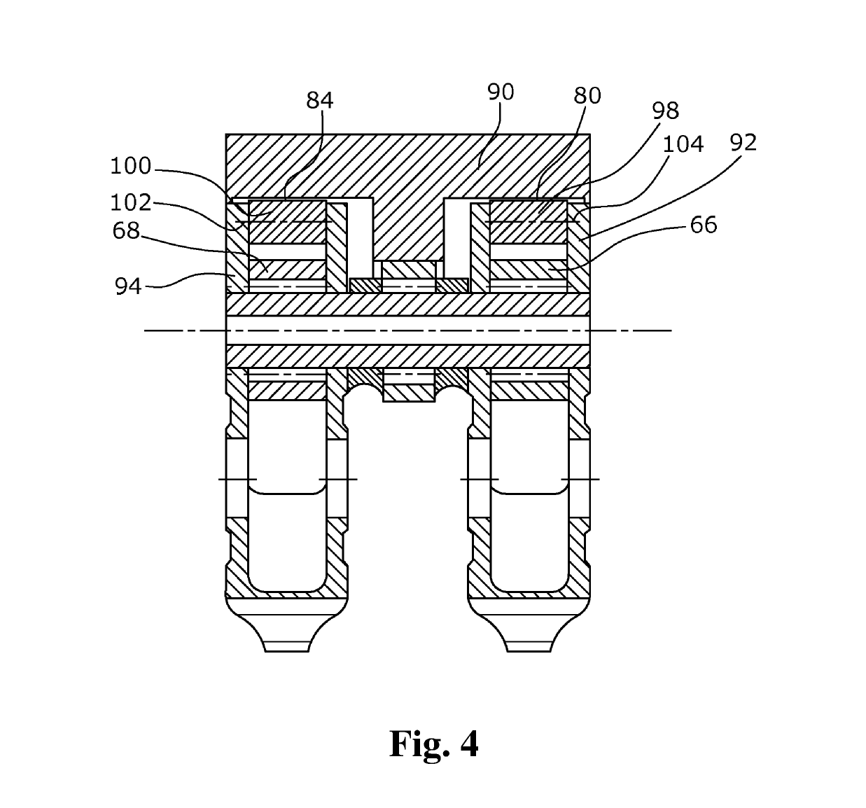

FIG. 4 now shows a sectional view of an embodiment of a transmission assembly according to the present invention that has the advantage of requiring less constructional space. For this purpose, transmission elements 92, 94 are formed with an increased length on the side oriented toward slotted guide module 90, whereby it becomes possible to arrange mounting member 98, 100 above the cam following roller elements 66, 68 on a rotary axis 102, 104, the cam following roller elements 66, 68 again rolling on slotted guide tracks 80, 84.

The present invention is not limited to embodiments described herein; reference should be had to the appended claims.

What is claimed is:

1-5. (canceled)

6. A transmission assembly for a mechanically controllable valve train, the transmission assembly comprising:
at least one gas exchange valve;
at least one coupling element;
a slotted guide module comprising slotted guide tracks;
mounting members;
a camshaft;
cam following roller elements;
at least two transmission elements,
each of the at least two transmission elements being configured so that a respective transmission element is directly or indirectly in an operative connection with one of the at least one gas exchange valve via one of the at least eon coupling element,
the at least two transmission elements being mounted via the mounting members in a respective one of the slotted guide tracks of the at least one slotted guide module, and
each of the at least two transmission elements being in an operative connection with the camshaft via the cam following roller elements; and
a valve stroke adjustment device configured to set different maximum strokes of a respective one of the at least one gas exchange valve,
wherein,
the mounting members and the cam following roller elements are mounted on a rotary axis, and
each of the cam following roller elements has two mounting members assigned thereto so as to increase a rigidity of the rotary axis.

7. The transmission assembly as recited in claim 6, wherein the slotted guide tracks comprises outer slotted guide tracks, each of which comprise a guide edge arranged at a respective outer side.

8. The transmission assembly as recited in claim 6, wherein the mounting members are arranged serially in a row.

9. The transmission assembly as recited in claim 6, wherein the mounting members comprise outer mounting members which are configured to extend above the cam following roller elements.

10. A mechanically controllable valve train comprising the transmission assembly as recited in claim 6, wherein at least two serially arranged gas exchange valves are assigned a transmission assembly.
